(19) United States
(12) Patent Application Publication
(10) Pub. No.: US 2017/0371169 A1
(43) Pub. Date: Dec. 28, 2017

(54) LENS GRATES, THREE DIMENSIONAL (3D) DISPLAY DEVICES, AND ELECTRONIC DEVICES

(71) Applicant: Wuhan China Star Optoelectronics Technology Co., Ltd., Wuhan, Hubei (CN)

(72) Inventor: Chang XIE, Shenzhen, Guangdong (CN)

(73) Assignee: Wuhan China Star Optoelectronics Technology Co., Ltd., Wuhan, Hubei (CN)

(21) Appl. No.: 15/111,014

(22) PCT Filed: Jun. 22, 2016
(86) PCT No.: PCT/CN2016/086720

§ 371 Date: Jul. 12, 2016

(30) Foreign Application Priority Data
May 26, 2016 (CN) 201610361769.5

(51) Int. Cl. G02B 27/22; G02F 1/1347; G02F 1/13; G02F 1/29; G02B 5/18

(52) U.S. Cl. CPC G02B 27/22; G02F 1/29; G02B 5/18; G02F 1/13; G02F 1/1347

(57) ABSTRACT

The present disclosure relates to a lens grate having a first substrate and a second substrate opposite to the first substrate, a first electrode layer on the first substrate, a resin layer on the first electrode layer, a second electrode layer on the second substrate, and a liquid crystal layer between the resin layer and the second electrode layer. One side of the resin layer facing toward the liquid crystal layer is configured with a plurality of concave spherical surfaces. By configuring the concave spherical surfaces, the thickness of the liquid crystal layer is gradually decreased along the direction from the center area to the rim area from regardless of the viewing directions, i.e., top-down, left-right, or slant, and thus the viewing angle is wide. With such design, the viewing angle of the 3D effect may be enlarged so as to enhance the 3D display performance.

### CROSS REFERENCE

This application claims the priority of Chinese Patent Application No. 201610361769.5, entitled “Lens grates, 3D display devices, and electronic devices”, filed on May 26, 2016, the disclosure of which is incorporated herein by reference in its entirety.

### FIELD OF THE INVENTION

The present invention relates to liquid crystal display field, and more particularly to a lens grate, a 3D display device, and an electronic device.

### BACKGROUND OF THE INVENTION

Naked 3D display technology is capable of displaying 3D images when viewing texts and images without dedicated glasses, which can adapt to users habits, and thus is the main trend of 3D display technology.

Currently, the naked 3D display device may include two viewpoint areas. The viewing angle is narrow, that is, users may view the 3D display images in these two areas. When users eyes are not within the two areas, only 2D images or double images may be seen, or even nothing can be seen. Thus, it is needed to provide a liquid crystal display device with a larger viewing angle.

### SUMMARY OF THE INVENTION

The present disclosure relates to a lens grate for enlarging the viewing angle of the 3D display device so as to enhance the display performance.

The present disclosure relates to a 3D display device incorporating the above lens grate.

The present disclosure relates to an electronic device incorporating the above 3D display device.

In one aspect, a lens grate includes: a first substrate and a second substrate opposite to the first substrate, a first electrode layer on the first substrate, a resin layer on the first electrode layer, a second electrode layer on the second substrate, a liquid crystal layer between the resin layer and the second electrode layer, and one side of the resin layer facing toward the liquid crystal layer is configured with a plurality of concave spherical surfaces.

Wherein the concave spherical surface is a concave hemisphere surface.

Wherein the concave spherical surfaces are connected in a head-to-tail arrangement.

Wherein a radius of the concave spherical surface is configured to be in a range from 2.5 um to 25 um.

Wherein the first electrode layer is a common electrode layer, and the second electrode layer is a pixel electrode layer.

In another aspect, a three-dimensional (3D) display device includes:

a lens grate, a liquid crystal panel, and a backlight module stacked in sequence, wherein the lens grate comprises a first substrate and a second substrate opposite to the first substrate, a first electrode layer on the first substrate, a resin layer on the first electrode layer, a second electrode layer on the second substrate, a liquid crystal layer between the resin layer and the second electrode layer, and one side of the resin layer facing toward the liquid crystal layer is configured with a plurality of concave spherical surfaces.

Wherein the concave spherical surface is a concave hemisphere surface.

Wherein the concave spherical surfaces are connected in a head-to-tail arrangement.

Wherein a radius of the concave spherical surface is configured to be in a range from 2.5 um to 25 um.

In one aspect, an electronic device includes: a 3D display device having a lens grate, a liquid crystal panel, and a backlight module stacked in sequence, wherein the lens grate comprises a first substrate and a second substrate opposite to the first substrate, a first electrode layer on the first substrate, a resin layer on the first electrode layer, a second electrode layer on the second substrate, a liquid crystal layer between the resin layer and the second electrode layer, and one side of the resin layer facing toward the liquid crystal layer is configured with a plurality of concave spherical surfaces.

Wherein the concave spherical surface is a concave hemisphere surface.

Wherein the concave spherical surfaces are connected in a head-to-tail arrangement.

Wherein a radius of the concave spherical surface is configured to be in a range from 2.5 um to 25 um.

Wherein the first electrode layer is a common electrode layer, and the second electrode layer is a pixel electrode layer.

By configuring the concave spherical surfaces, the thickness of the liquid crystal layer is gradually decreased along the direction from the center area to the rim area from regardless of the viewing directions, i.e., top-down, left-right, or slant, and thus the viewing angle is wide. With such design, the viewing angle of the 3D effect may be enlarged so as to enhance the 3D display performance. The viewing angles of the 3D display device and the electronic device is large and the 3D display performance are better.

### BRIEF DESCRIPTION OF THE DRAWINGS

In order to more clearly illustrate the embodiments of the present invention or prior art, the following figures will be described in the embodiments are briefly introduced. It is obvious that the drawings are merely some embodiments of the present invention, those of ordinary skill in this field can obtain other figures according to these figures without paying the premise.

FIG. 1 is a schematic view of the 3D display device in accordance with one embodiment.

FIG. 2 is a schematic view of the lens grate of the 3D display device of FIG. 1.

FIG. 3 is a top view of the resin layer of the lens grate of FIG. 2.

FIG. 4 is a schematic view showing optical path when the voltage is applied to the electrode layer of the lens grate of FIG. 2.

### DETAILED DESCRIPTION OF PREFERRED EMBODIMENTS

Embodiments of the present invention are described in detail with the technical matters, structural features, achieved objects, and effects with reference to the accompanying drawings as follows. It is clear that the described embodiments are part of embodiments of the present invention, but not all embodiments. Based on the embodiments of the present invention, all other embodiments to those of ordinary skill in the premise of no creative efforts obtained, should be considered within the scope of protection of the present invention.

In the present disclosure, it should be understood that the term “Up”, “Down”, “front”, “rear”, “Left”, “Right”, “inside”, “outside”, “lateral”, etc., is only based on the drawings to illustrate the orientation or positional relationship, but not to indicate or imply device or element referred to must have a particular orientation. Therefore, the present disclosure should not be construed as restrictions.

In the present disclosure, it should be noted that unless otherwise clearly defined and limited, the term “mounted,” “connected,” “connected” to be broadly understood, for example, can be a fixed connection, a detachable connection, or integrally connected; can be mechanically connected, or may be electrically connected; can be directly connected, or may be connected indirectly through intermediary, the two elements may be internal communication. Those of ordinary skill in the art can understand the above-described circumstances in terms of the present disclosure.

Furthermore, in the present disclosure, unless otherwise indicated, “a plurality of” means two or more. If the term “step” in the present specification appear, which means not only a separate step, while no clear distinction with other processes, this step can be realized as long as the intended function is also included. In this specification, the symbol “˜” indicates the numerical range before and after the symbol “˜”, respectively, as described, including the maximum and minimum values of the range. In the drawings, similar or identical structural units represented by the same reference numerals.

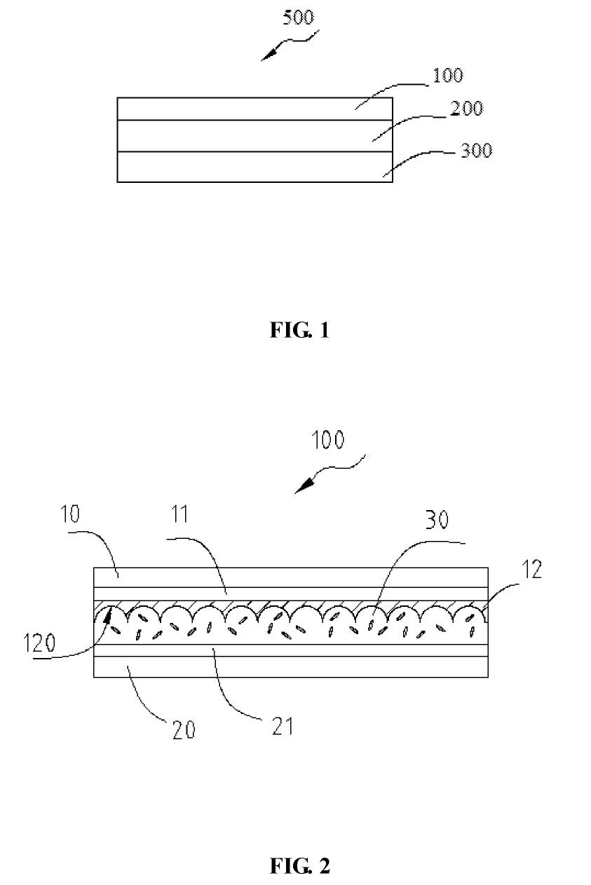

Referring to FIGS. 1 and 2, the 3D display device 500 includes a lens grate 100, a liquid crystal panel 200, and a backlight module 300 stacked in sequence. The lens grate 100 includes a first substrate 10, a first electrode layer 11, a resin layer 12, a liquid crystal layer 30, a second electrode layer 21, and a second substrate 20. The first substrate 10 is opposite to the second substrate 20. The first electrode layer 11 is arranged on one side of the first substrate 10 close to the second substrate 20. The resin layer 12 is arranged on the first electrode layer 11. The second electrode layer 21 is arranged on one side of the second substrate 20 close to the first substrate 10. The liquid crystal layer 30 is arranged between the resin layer 12 and the second electrode layer 21. The liquid crystal molecules within the liquid crystal layer 30 are negative liquid crystals. That is, the liquid crystal layer 30 is a negative liquid crystal layer. Further, one side of the resin layer 12 facing toward the liquid crystal layer 30 includes a plurality of concave spherical surfaces, and the center of the spherical surface leans forward the liquid crystal layer 30.

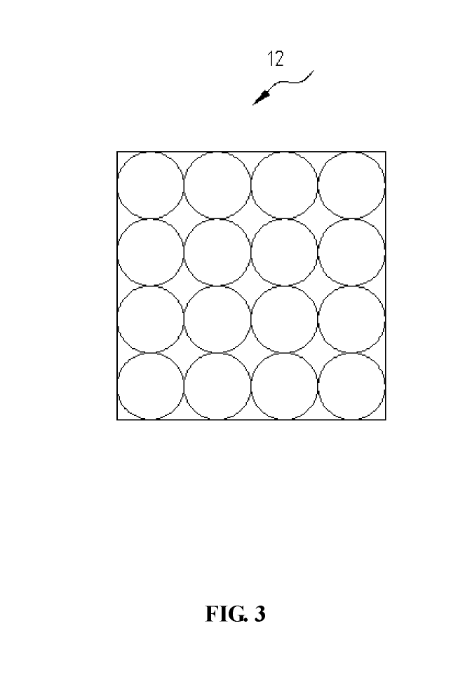

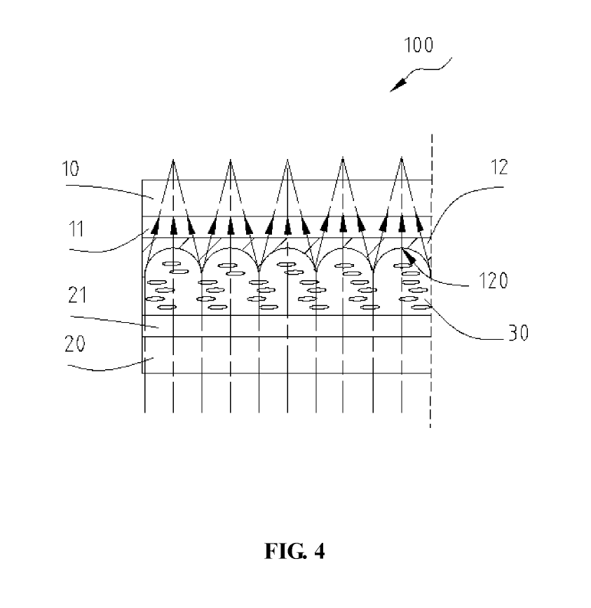

Referring to FIG. 2, when the first electrode layer 11 and the second electrode layer 21 are not applied with a voltage, as the negative liquid crystal molecules have initial alignment and are in isotropic state, optical focus may not occur on the lens grate 100 when light beams pass through the liquid crystal layer in the isotropic state. At this moment, the display device is in the 2D display state. Referring to FIG. 3, when the first electrode layer 11 and the second electrode layer 21 are not applied with the voltage, the native liquid crystal molecules are horizontally arranged gradually due to the force of the electrical field. At this moment, due to the design of the concave spherical surface 120 on the resin layer 12, the thickness of the middle area is greater than the thickness of the rim area, and thus the middle area of the concave spherical surface 120 may receive more negative liquid crystal molecules. Also, the thickness of the rim area of the concave spherical surface 120 is smaller, and the rim area of the concave spherical surface 120 may receive less negative liquid crystal molecules. That is, the thickness of the liquid crystal layer 30 of each of the concave spherical surface 120 is gradually decreased along a direction from the center area to the rim area. At this moment, the light beams (dashed arrows in FIG. 3 relate to the optical path) may generate optical focus when passing through the liquid crystal layer 30 with a gradually-changed alignment, and the display device is in the 2D display state. Also, the thickness of the liquid crystal layer is gradually decreased along the direction from the center area to the rim area from regardless of the directions, i.e., top-down, left-right, or slant directions, and thus the viewing angle is wide. With such design, the viewing angle of the 3D effect may be enlarged so as to enhance the 3D display performance.

It can be understood that the liquid crystal panel 200 includes a plurality of pixel areas (not shown), and each of the pixel areas includes a plurality of sub-pixel areas (not shown). To ensure a better 3D display performance, each of the sub-pixel areas of the liquid crystal panel 200 correspond to one or a plurality of concave spherical surfaces 120.

Further, in order to obtain continuous image to ensure better display performance, preferably, the concave spherical surfaces 120 are connected in a head-to-tail arrangement. In other words, there is no gap between the connected concave spherical surfaces 120.

Preferably, to enlarge the viewing angle to the largest extent, the concave spherical surface 120 is configured to be a concave hemisphere surface, that is, the depth of the concave spherical surface 120 equals to the radius of the hemisphere.

It can be understood that the radius (r) of each of the concave spherical surfaces 120 may be configured accordingly. The adjustment of the viewing angle may be more precise when the radius (r) of the concave spherical surface 120 is configured to be smaller, which enhances the farsighted or shortsighted issues. Preferably, the radius (r) of the concave spherical surface 120 is configured to be in a range from 2.5 um to 25 um such that each of the sub-pixel areas corresponds to at least one concave spherical surface 120. In addition, to obtain uniformly displayed image, the radius (r) of each of the concave spherical surfaces 120 are the same.

In one embodiment, the first substrate 10 is a color film substrate, the first electrode layer 11 is a common electrode layer, the second substrate 20 is an array substrate, and the second electrode layer 21 is a pixel electrode layer. Further, the first substrate 10 and the second substrate 20 may be made by glass or other transparent material, such as PET, APET, PC, PMMA, or glass, which may be selected by persons skilled in the art according to real scenario.

Preferably, in one embodiment, the resin layer 12 may be a UV resin layer for the reason that the manufacturing efficiency of the UV resin layer is higher, which enhances the manufacturing efficiency of the whole pillar-shaped grating membrane. At the same time, the volatile organic compound of the UV resin layer is a few, and thus does not cause harmful effects to the environment.

The present disclosure also relates to an electronic device adopting any one of the 3D display device 500 in the above. The electronic device may include products or components having display functions, but not limited to, e-papers, liquid crystal TVs, mobile phones, digital frames, tablets.

In the present disclosure, the terms “one embodiment,” “some embodiments”, “an example”, “specific example”, or “some examples” and other means of description in connection with the embodiment or example describe the particular feature, structure, material, or characteristic included in at least one embodiment or examples of the claimed invention. In the present disclosure, the terms of the above schematic representation is not necessarily for the same embodiment or example. Furthermore, the particular features, structures, materials, or characteristics described in any one or more of the examples or embodiments may be combined in an appropriate manner.

Above are embodiments of the present invention, which does not limit the scope of the present invention. Any modifications, equivalent replacements or improvements within the spirit and principles of the embodiment described above should be covered by the protected scope of the invention.

What is claimed is:

1. A lens grate, comprising:
a first substrate and a second substrate opposite to the first substrate, a first electrode layer on the first substrate, a resin layer on the first electrode layer, a second electrode layer on the second substrate, a liquid crystal layer between the resin layer and the second electrode layer, and one side of the resin layer facing toward the liquid crystal layer is configured with a plurality of concave spherical surfaces.

2. The lens grate as claimed in claim 1, wherein the concave spherical surface is a concave hemisphere surface.

3. The lens grate as claimed in claim 1, wherein the concave spherical surfaces are connected in a head-to-tail arrangement.

4. The lens grate as claimed in claim 1, wherein a radius of the concave spherical surface is configured to be in a range from 2.5 um to 25 um.

5. The lens grate as claimed in claim 1, wherein the first electrode layer is a common electrode layer, and the second electrode layer is a pixel electrode layer.

6. A three-dimensional (3D) display device, comprising:
a lens grate, a liquid crystal panel, and a backlight module stacked in sequence, wherein the lens grate comprises a first substrate and a second substrate opposite to the first substrate, a first electrode layer on the first substrate, a resin layer on the first electrode layer, a second electrode layer on the second substrate, a liquid crystal layer between the resin layer and the second electrode layer, and one side of the resin layer facing toward the liquid crystal layer is configured with a plurality of concave spherical surfaces.

7. The 3D display device as claimed in claim 6, wherein the concave spherical surface is a concave hemisphere surface.

8. The 3D display device as claimed in claim 6, wherein the concave spherical surfaces are connected in a head-to-tail arrangement.

9. The 3D display device as claimed in claim 6, wherein a radius of the concave spherical surface is configured to be in a range from 2.5 um to 25 um.

10. An electronic device, comprising:
a 3D display device having a lens grate, a liquid crystal panel, and a backlight module stacked in sequence, wherein the lens grate comprises a first substrate and a second substrate opposite to the first substrate, a first electrode layer on the first substrate, a resin layer on the first electrode layer, a second electrode layer on the second substrate, a liquid crystal layer between the resin layer and the second electrode layer, and one side of the resin layer facing toward the liquid crystal layer is configured with a plurality of concave spherical surfaces.

11. The electronic device as claimed in claim 10, wherein the concave spherical surface is a concave hemisphere surface.

12. The electronic device as claimed in claim 10, wherein the concave spherical surfaces are connected in a head-to-tail arrangement.

13. The electronic device as claimed in claim 10, wherein a radius of the concave spherical surface is configured to be in a range from 2.5 um to 25 um.

14. The electronic device as claimed in claim 10, wherein the first electrode layer is a common electrode layer, and the second electrode layer is a pixel electrode layer.
